(19) United States
(12) Patent Application Publication
(10) Pub. No.: US 2026/0023160 A1
(43) Pub. Date: Jan. 22, 2026

(54) METHODS, ARCHITECTURES, APPARATUSES AND SYSTEMS FOR OBJECT DETECTION OVER WIRELESS NETWORKS

(71) Applicant: InterDigital Patent Holdings, Inc., Wilmington, DE (US)

(72) Inventors: Mohammad Heggo, Lewisham (GB); Arman Shojaeifard, London (GB); Yasser Mestrah, Uxbridge (GB); Ibrahim Hemadeh, Hemel Hempstead (GB); Javier Lorca Hernando, Madrid (ES); Alain Mourad, Ascot (GB)

(21) Appl. No.: 18/777,104

(22) Filed: Jul. 18, 2024

(51) Int. Cl. G01S 7/41; G01S 7/00; G01S 13/00; G01S 13/86

(52) U.S. Cl. CPC G01S 7/412; G01S 7/006; G01S 7/415; G01S 13/003; G01S 13/86

(57) ABSTRACT

Procedures, methods, architectures, apparatuses, systems, devices, and computer program products are provided for object detection over a wireless network. A method performed by a wireless transmit/receive unit (WTRU) includes receiving, from a wireless network, a configuration that includes a configured target profile for a target and information indicative of an identification of the target, wherein the configured target profile comprises a radar cross section profile associated with the target; receiving at least one signal from the wireless network; generating a measured profile based on the at least one signal; determining that the at least one signal was reflected by the target based at least in part on the information indicative of the identification of the target and a comparison between the configured target profile and the measured profile; and performing sensing measurements associated with the target using the at least one signal based at least in part on the determination.

### TECHNICAL FIELD

The present disclosure is generally directed to the fields of communications, software and encoding, including, for example, to methods, architectures, apparatuses, systems related to integrated sensing and communication (ISAC) (e.g., detecting a target object based on configuration of at least one of a wireless transmit/receive unit or a wireless network).

### BACKGROUND

Different objects can have different characteristics (e.g., shape, size, material, vibration, rotation, etc.). These characteristics may determine how objects scatter one or more incident reference signals (RSs), thus impacting their corresponding radar cross section (RCS). The RCS of an object may be associated with a specific pattern depending on the variation of the aspect angle (e.g., as defined by the average angle of incidence and/or scattering angle) and/or the frequency of incident radio signals. As used herein, an RCS profile (e.g., including an RCS angular profile, RCS frequency profile, or any other suitable RCS profile) may refer to how RCS patterns are recorded over a range of incidence angles, scattering angles, signal frequencies, or any combination thereof.

A detecting or sensing scenario includes a bistatic transmission-reception point (TRP) (e.g., any suitable network element) coupled to a wireless transmit/receive unit (WRTU). A detecting or sensing target may be in the line-of-sight (LoS) of both the TRP and the WRTU. As part of a detection or sensing operation, an RS may be transmitted from the TRP in the direction of the sensing target, which reflects this transmitted signal toward the WRTU.

3GPP Rel-17/18 support the exchange of PRS line-of-sight (LoS)/non-line-of-sight (NLOS) indication information between a WTRU and a RAN using a location management function (LMF). This indication information can be either hard (e.g., indicating an LoS or NLOS arrangement) or soft (e.g., an integer value that represents a likelihood of whether or not a propagation path is LoS). However, such a LoS/NLOS indication may not be sufficient for certain sensing or detection applications.

### SUMMARY

In accordance with certain embodiments of the present disclosure, a method is performed by a wireless transmit/receive unit (WTRU). The method includes receiving, from a wireless network, a configuration that includes a configured target profile for a target and information indicative of an identification of the target, wherein the configured target profile includes a radar cross section profile associated with the target. The method also includes receiving at least one signal from the wireless network, and generating a measured profile based on the at least one signal. The method also includes determining that the at least one signal was reflected by the target based at least in part on the information indicative of the identification of the target and a comparison between the configured target profile and the measured profile. The method also includes performing sensing measurements associated with the target using the at least one signal based at least in part on the measured profile.

In a first embodiment of the method, the configured target profile also includes an aspect of the at least one signal, the aspect including at least one of positioning information, a power, a power per path, a phase, an amplitude, a frequency, an angle-of-arrival, a signal-to-interference-noise ratio, a signal quality, a rank indicator, a precoding matrix indicator, a density, a comb size, a number of frequency hops, a beam ID, a periodicity, a repetition factor, or a timing advance.

In a second embodiment of the method, the configured target profile also includes a set of values, each value of the set of values corresponding to a respective at least one of a frequency, time, phase, resource block of the WTRU, or angle-of-arrival.

In a third embodiment of the method, the information indicative of the identification of the target includes a condition associated with a property of the at least one signal, wherein the property includes at least one of a signal type, pattern, density, cover code, periodicity, power, beam identification, transmission configuration indicator, or quasi colocation information, and the determining is in response to the condition being satisfied.

In a fourth embodiment of the method, the determining includes evaluating a difference between the configured target profile and the measured profile, comparing the difference to a threshold, and making the determination based on the comparison.

In a fifth embodiment of the method, the determining includes evaluating a correlation between the configured target profile and the measured profile, comparing the correlation to a threshold, and making the determination based on the comparison.

In a sixth embodiment of the method, the configured target profile also includes sensing assistance information including one or more absolute coordinate sets associated with the target, one or more relative, with respect to the WTRU, coordinate sets associated with the target, one or more physical areas associated with the target, mobility information associated with the target, or reflection information associated with the target, and the determining is further based on the sensing assistance information.

A seventh embodiment of the method also includes transmitting a message including information associated with the sensing measurements to the wireless network.

An eighth embodiment of the method also includes transmitting a sensing capability to the wireless network, wherein the configuration is based on the sensing capability.

In a first implementation of that eighth embodiment, the sensing capability includes at least one of an inverse frequency transform capability, a maximum sampling rate or number of samples, a sensing frequency range, a sensing bandwidth, one or more available sensing modes, a list of sensing priorities, a sensing spatial resolution, a sensing temporal resolution, a capability or resolution for supporting angular measurements, a sensing doppler resolution, a sensitivity to reflectivity, a minimum power requirement, a minimum SNR requirement, an absolute amplitude range, a capability to for supporting phase measurements, an indication of half-duplex or full-duplex sensing, an indication of monostatic or bistatic sensing, or a maximum allowed transmit power associated with transmitting the sensing capability.

In accordance with certain embodiments of the present disclosure, a wireless transmit/receive unit (WTRU) includes a processer, and a transceiver coupled to the processer. The WTRU is to receive, from a wireless network, a configuration that includes a configured target profile for a target and information indicative of an identification of the target, wherein the configured target profile includes a radar cross section profile associated with the target, receive at least one signal from the wireless network, generate a measured profile based on the at least one signal, determine that the at least one signal was reflected by the target based at least in part on the information indicative of the identification of the target and a comparison between the configured target profile and the measured profile, and perform sensing measurements associated with the target using the at least one signal based at least in part on the measured profile.

In a first embodiment of the WTRU, the configured target profile also includes an aspect of the at least one signal, the aspect including at least one of positioning information, a power, a power per path, a phase, an amplitude, a frequency, an angle-of-arrival, a signal-to-interference-noise ratio, a signal quality, a rank indicator, a precoding matrix indicator, a density, a comb size, a number of frequency hops, a beam ID, a periodicity, a repetition factor, or a timing advance.

In a second embodiment of the WTRU, the configured target profile also includes a set of values, each value of the set of values corresponding to a respective at least one of a frequency, time, phase, resource block of the WTRU, or angle-of-arrival.

In a third embodiment of the WTRU, the information indicative of the identification of the target includes a condition associated with a property of the at least one signal, the property includes least one of a signal type, pattern, density, cover code, periodicity, power, beam identification, transmission configuration indicator, or quasi colocation information, and the determination is in response to the condition being satisfied.

In a fourth embodiment of the WTRU, the determination includes evaluating a difference between the configured target profile and the measured profile, comparing the difference to a threshold, and making the determination based on the comparison.

In a fifth embodiment of the WTRU, the determination includes evaluating a correlation between the configured target profile and the measured profile, comparing the correlation to a threshold, and making the determination based on the comparison.

In a sixth embodiment of the WTRU, the configured target profile also includes sensing assistance information including one or more absolute coordinate sets associated with the target, one or more relative, with respect to the WTRU, coordinate sets associated with the target, one or more physical areas associated with the target, mobility information associated with the target, or reflection information associated with the target, and the determining is further based on the sensing assistance information.

In a seventh embodiment of the WTRU, the WTRU is further to transmit a message including information associated with the sensing measurements to the wireless network.

In an eighth embodiment of the WTRU, the WTRU is further to report a sensing capability to the wireless network, wherein the configuration is based on the sensing capability.

In a first implementation of that eighth embodiment, the sensing capability includes at least one of an inverse frequency transform capability, a maximum sampling rate or number of samples, a sensing frequency range, a sensing bandwidth, one or more available sensing modes, a list of sensing priorities, a sensing spatial resolution, a sensing temporal resolution, a capability or resolution for supporting angular measurements, a sensing doppler resolution, a sensitivity to reflectivity, a minimum power requirement, a minimum SNR requirement, an absolute amplitude range, a capability to for supporting phase measurements, an indication of half-duplex or full-duplex sensing, an indication of monostatic or bistatic sensing, or a maximum allowed transmit power associated with transmitting the sensing capability.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a depiction of illustrative properties associated with a transmitted signal;

FIG. 3 is a depiction of an illustrative method for performing sensing measurements at a WTRU;

FIG. 4 is an illustrative depiction of how signal reflections can be detected by a WTRU;

FIG. 5 is an illustrative depiction of how a WTRU can receive multiple reference signals; and

FIG. 6 is an illustrative depiction of geometric relationships that may be used for object detection.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

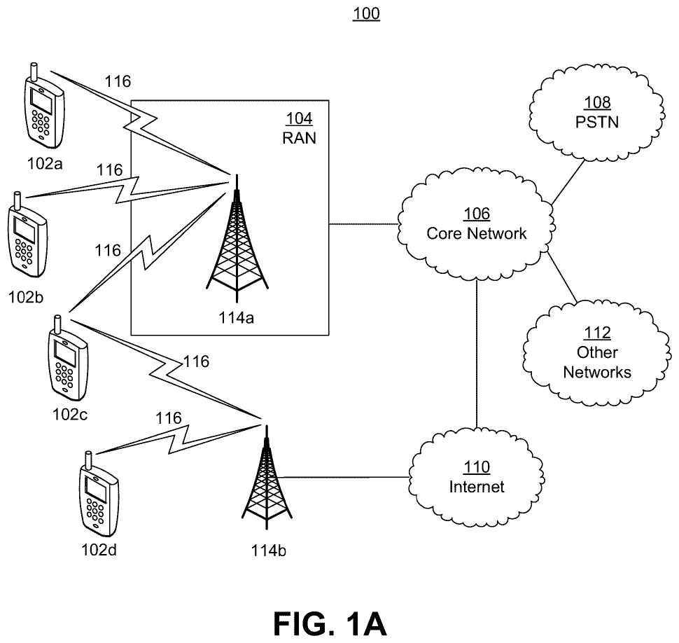

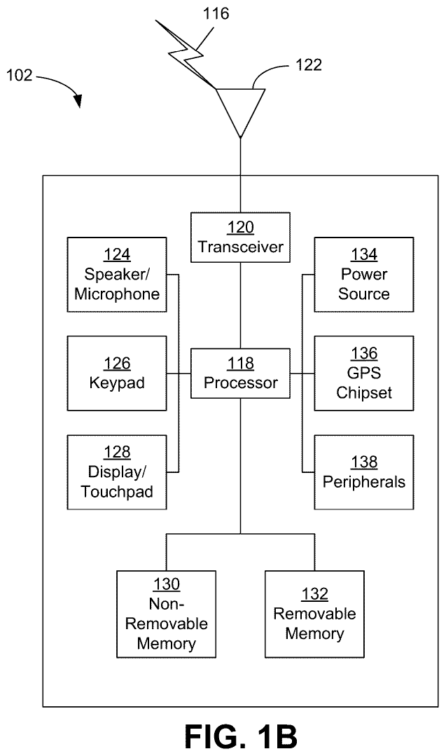

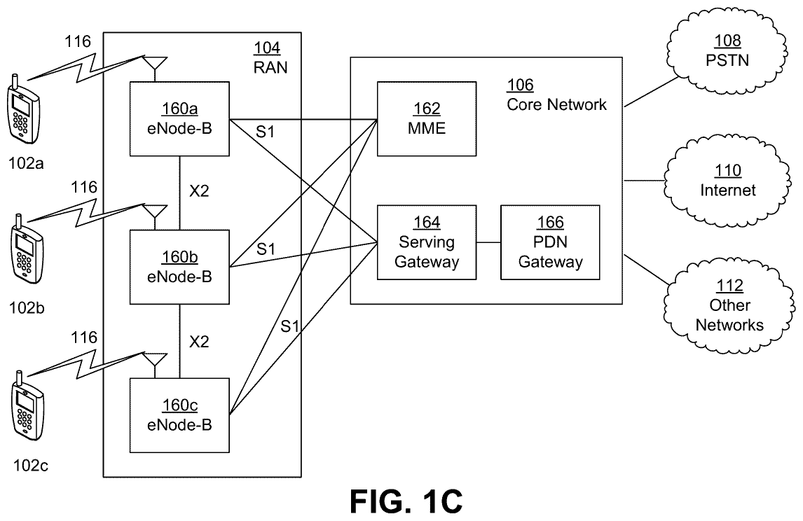

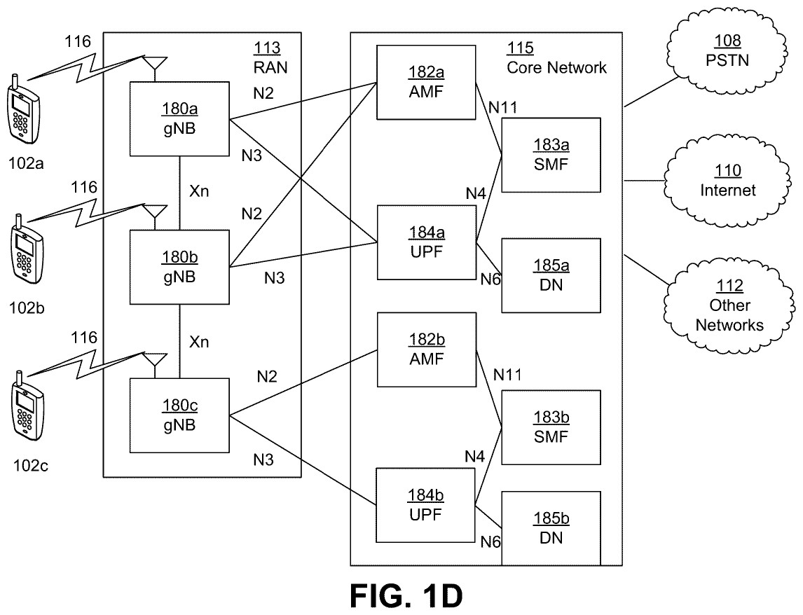

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an cNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home cNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and it may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors. These sensors may include any one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, a humidity sensor, or any other suitable sensor.

The WTRU 102 may include a full duplex radio for which transmission and reception of some or all of the signals (e.g., associated with particular subframes for both the uplink (e.g., for transmission) and downlink (e.g., for reception)) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the Node-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the cNode-Bs 160a, 160b, 160c in the RAN 104 via the SI interface. The SGW 164 may generally route and forward user data packets to/from the WTRUs 102a, 102b, 102c. The SGW 164 may perform other functions, such as anchoring user planes during inter-cNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHZ, 40 MHZ, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHZ, 2 MHZ, 4 MHZ, 8 MHz, and 16 MHz bandwidths using non-TVWS spectrum. According to a representative embodiment, 802.1 lah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode) transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, cNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (cMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, cNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As provided in detail below, methods, systems, and devices are provided to detect reflected signals from a target based on reference signal measurements and a target profile. For example, a WTRU is configured for this detection using a configured target profile and a measured profile based on receiving a reference signal. When the measured profile corresponds to the target, it may be referred to as a measured target profile. Either of the measured profile or the measured target profile may be used for sensing measurements. Also, for example, the WTRU detects reflections from the target based on associations between RS measurements and a configured target RCS profile. Further, for example, the detection involves receiving a network configuration, detecting and/or measuring signals reflected from a target, and reporting detected reflected signal components to the network. Still further, for example, the WTRU receives a network configuration for a measurement event, and the measurement event affects how the WTRU generates the associations between the RS measurements and the configured target RCS profile.

In certain representative embodiments, methods are provided to detect and/or determine a set of one or more reflected reference signals from a sensing target. For example, the set of the one or more reflected reference signals from the sensing target are based at least in part on at least one of one or more reference signal measurements, a configured target profile, combinations of the same, or the like.

In certain representative embodiments, the configured target profile includes a target RCS profile. For example, target reflection detection is provided based at least in part on the target RCS profile.

In certain representative embodiments, a WTRU provides for target reflection detection. For example, the WTRU provides for the target reflection detection using at least one of a reference target profile, one or more measurements for a reference signal, combinations of the same, or the like. Also, for example, the provision, e.g., at the WTRU, of target reflection detection includes at least one of an initial configuration of the WTRU, the WTRU receiving sensing assistance information, receiving one or more reference signals, performing one or more configured measurements, determining of target reflection detection, reporting a detected RS ID reflected from a target, combinations of the same, or the like.

In certain representative embodiments, a WTRU detects one or more reflections from a sensing target. For example, the WTRU detects the one or more reflections from the sensing target based at least in part on one or more associations between one or more RS measurements and/or a configured target RCS profile. Also, for example, the WTRU detects the one or more reflections from the sensing target by performing at least one of: receiving a configuration from a network; detecting and/or measuring one or more signals reflected from a sensing target based on at least one of one or more measurement event configurations (e.g., information indicative of an identification of a target), a configured target profile, one or more thresholds, combinations of the same, or the like; reporting one or more detected reflected signal multipath components to the network; combinations of the same; or the like.

In certain representative embodiments, a WTRU receives a configuration from a network for a measurement event (e.g., corresponding to a target reflection detection). For example, the configuration includes at least one of measurement event triggering and reporting conditions, one or more measurement event IDs, one or more sensing RS configurations, sensing assistance information (e.g., sensing target profile information), sensing target positioning information, combinations of the same, or the like.

In certain representative embodiments, the WTRU detects the one or more reflections from the sensing target based at least in part on the one or more associations between the one or more RS measurements and the configured target RCS profile. For example, the detection of one or more target reflections by the WTRU is applied to at least one of sparse target sensing (e.g. for sensors in low-power mode), target detection, target misdetection, environment monitoring, combinations of the same, or the like.

### Overview

When a WRTU receives an RS that is reflected by a sensing target, the channel gain H of the received RS can be formulated as:

$$H = H ( D 1 ) \times {RCS}_{ST} \times H ( D 2 ) \qquad ( 1 )$$

where D1 and D2 are the separation distances between the sensing target and the TRP and between the sensing target and the WTRU, respectively; H(D1) and H(D2) are the channel gains corresponding to the RS propagation across distances D1 and D2, respectively; the combined distance D1+D2 represents the overall propagation path length of the RS; and RCS_{sT} is the sensing target RCS.

The path loss for the RS can be calculated (e.g., in dB) as:

$${PL}_{dB} = {PL}_{dB} ( D 1 ) + {PL}_{dB} ( D 2 ) - {RCS}_{ST , dB} \qquad ( 2 )$$

where RCS_{ST.dB} is the sensing target RCS (e.g., in dB). Equation (2) can be rewritten as:

$${PL}_{dB} = {PL}_{dB}^{dist} - {RCS}_{ST , dB} \qquad ( 3 )$$

where PL_{dB}^{dist} is the path loss component that depends on the distances D1 and D2. As used herein, PL_{dB}^{dlist} may be referred to as the distance path loss component because of how it quantifies the loss in signal strength during signal propagation (e.g., through the atmosphere, water, or any other suitable propagation medium over which a wireless communication link can be made).

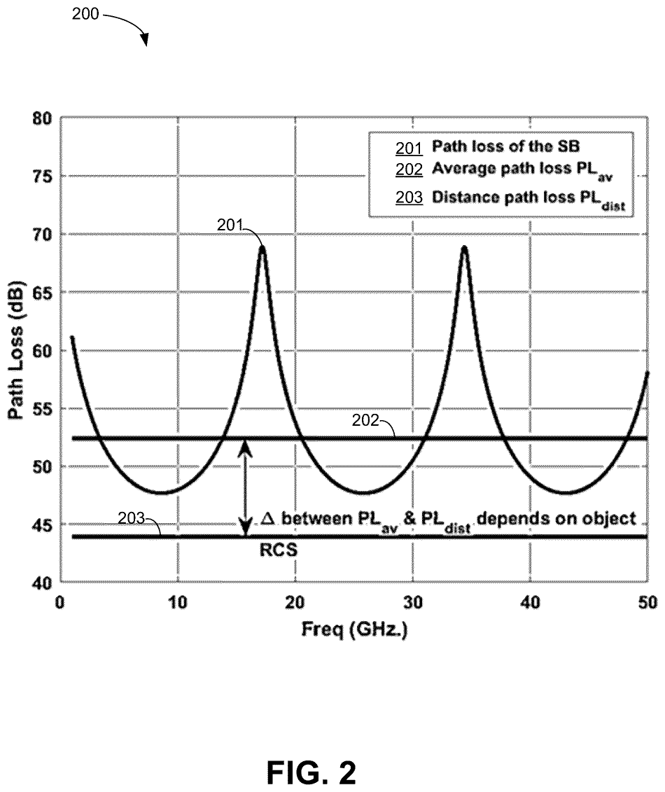

In certain embodiments, the WTRU can determine that the received RS is reflected from a specific sensing target by comparing the measured RCS profile (e.g., RCS frequency profile) or the measured average RCS to a predetermined, preconfigured, or other suitable reference RCS profile (e.g., including an expected average RCS) of the sensing target. For example, as shown in FIG. 2, the path loss of the sensing beam (SB) 201, which may correspond to the pass loss of the RS that is reflected from the object, has a characteristic pattern (e.g., a characteristic relationship between frequency and dB of the path loss) based on the target RCS profile. The path loss of the SB 201 may be associated with at least an average path loss 202 (PLav) and a distance path loss 203 (PLdist), each of which may be roughly constant across a frequency range of interest. As further shown in FIG. 2, the separation between PLav 202 and PLdist 203 may depend on an object (e.g., it may depend on the target RCS profile). This target RCS profile may correspond to RCS_{ST.dB} of Equations 2 or 3. Moreover, the difference between the average RS path loss and the RS path loss distance component can be demonstrated as being comparable to the average sensing target RCS.

In one illustrative sensing scenario, a gNB (e.g., any gNB described at least in connection with FIG. 1D) may transmit one or more RSs (e.g., a positioning RS (PRS)) in the direction of one or more sensing targets in an environment. The transmitted RS may be reflected by one or more targets (e.g., one or more sensing targets, one or more environmental objects, etc.), and a WTRU may receive one or more of these reflected RSs. As used herein, a target signal may refer to a transmitted RS that is received at a WTRU after reflecting off of at least one sensing target. As recorded at the WTRU, measurable data of the target signal (e.g., RS received power (RSRP), RS received power per path (RSRPP), signal to interference noise ratio (SINR), etc.) may exhibit different average values or profiles over different frequencies, incidences and/or scattering angles (e.g., frequency profile, angular profile, etc.) based on the target RCS profile. Moreover, these measurable data may depend on how the RS reflects off of one or more targets. In accordance with certain embodiments of the present disclosure, methods, architectures, apparatuses, and/or systems are provided for WTRU- or network-based target detection based on comparisons between data of a target signal and data of a target (e.g., its RCS profile).

In other embodiments, including certain embodiments consistent with the present disclosure, a method (e.g., with one or more supporting systems, apparatuses, and/or architectures) is provided for making associations between RS measurements and sensing target data based on the target profile. Thus, the present disclosure may provide for sensing use cases including target detection and target tracking. In certain embodiments, a WTRU associates RS measurements (e.g., target signal measurements) with a sensing target and optionally reports the target-related RS measurements to the network. In certain embodiments, the WTRU makes the aforementioned association based on comparisons between the RS measurements and a configurable target RCS profile (e.g., with the target RCS profile received by the WTRU over the network). For example, the target RCS profile may be preconfigured (e.g., based on known properties of the network, the WTRU, and/or the sensing target), the target RCS profile may be dynamically configured (e.g., based on adjustment instructions derived at the WTRU or the network, based on communications therebetween), or the target RCS profile may be preconfigured and dynamically configured. As used herein, configured information may refer to information that is preconfigured and/or dynamically configured.

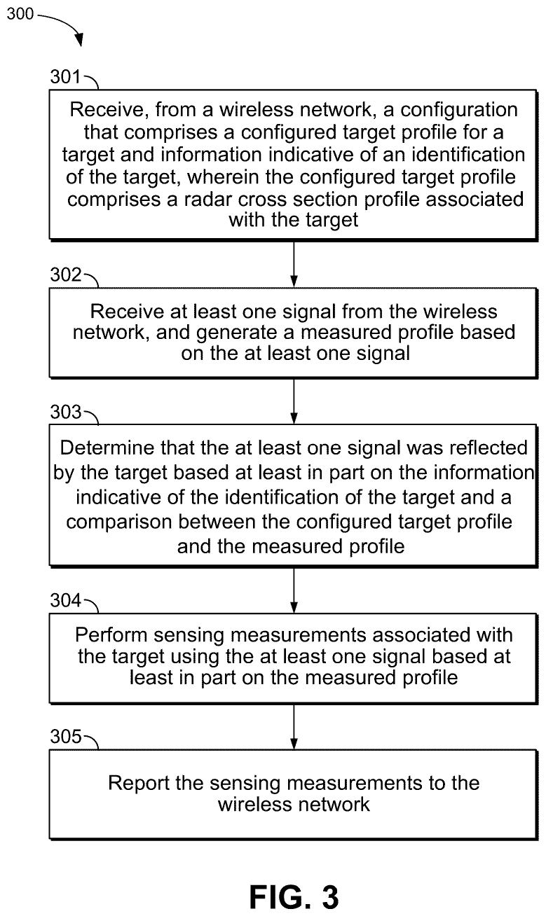

FIG. 3 shows an illustrative method 300, consistent with certain embodiments of the present disclosure, performed by a WTRU (e.g., any WTRU 102). For example, method 300 may be provided to sense a target (e.g., any suitable object) based on determining that at least one transmitted signal (e.g., an RS transmitted over air interface 116, or any other suitable medium, by a base station 114 or any other suitable component of RAN 104) was reflected by the target (e.g., target object 402).

Method 300 includes step 301, where the WTRU receives, from a wireless network (e.g., RAN 104, with or without instructions provided over core network 106) a configuration that includes a configured target profile for a target and information indicative of an identification of the target. The configured target profile includes a radar cross section (RCS) profile associated with the target. For example, the WTRU can receive the configuration over radio resource control (RRC) signaling, MAC control element (MAC-CE) signaling, downlink control information (DCI) signaling, or any other suitable communication protocol.

In certain embodiments, the information indicative of an identification of the target may be referred to as a measurement event. The measurement event can include one or more triggering configurations that are associated with the determination that occurs in connection with step 303. In certain embodiments, the measurement event otherwise or additionally includes one or more measurement configurations that are associated with at least the measuring that occurs in connection with step 304. The measurement configuration may specify, for example, one or more properties of the RS (e.g., RSRP, RSRPP, reference signal carrier phase (RSCP), angle-of-arrival (AoA), any other suitable property, or any combination thereof), one or more measurement profile types (e.g., a frequency, temporal, angular, or other suitable measurement, or any combination thereof), or any combination thereof that can be used to perform the sensing measurements at step 304; the triggering configuration may include, for example, one or more thresholds associated with any one or more of the aforementioned properties of the RS and/or measurement profiles.

In certain embodiments, the aforementioned triggering and/or measurement configurations may be used to initialize, update, and/or terminate a sensing operation of the WTRU, or a reporting (e.g., as occurs at optional step 305) by the WTRU of the sensing operation. Before or during the sensing operation, the triggering and/or measurement configurations may be updated (e.g., according to logic of the WTRU, instructions received at the WTRU, logic of a network element, instructions received at the network element, or any combination thereof).

In certain embodiments, the measurement conditions include an instruction (e.g., as is used at least in connection with step 304) for how to compare the at least one received signal (e.g., as is received at least at step 302) to the target profile signal. For example, the instruction may include calculating a difference between the received signal and the target profile signal, it may include calculating a correlation between the transmitted signal reflection and the target profile signal, or it may include a combination thereof.

In certain embodiments, the configuration of step 301 may also include (e.g., as part of the configured target profile or as part of a measurement event) sensing assistance information. The sensing assistance information can include details associated with one or more objects that are to be the focus of sensing measurements performed by the WTRU. The sensing assistance information can include, for example, a target identifier (e.g., that identifies a category associated with the target, such as a drone), an association with the measurement event, sensing target profile information, and/or sensing target positioning information.

As considered in connection with any one of the configured target profiles, the information indicative of an identification of the target, or the sensing assistance information, the configuration may include one or more metrics of the RS (e.g., where the RS corresponds to the at least one signal received at step 302). A suitable metric of the RS may include, for example, any one or more of: frequency profile information (e.g., one or more frequency-dependent amplitudes, phase information associated with one or more frequencies or one or more physical resource blocks (PRBs), or any combination thereof); angular profile information (e.g., a received power associated with one or more AoAs and/or angles-of-departure (AODs)); or time profile information (e.g., a received power associated with one or more times or PRBs, or a received phase associated with one or more times or PRBs). Each metric of the RS may be absolute or relative. Each metric of the RS may be directly measurable by the WTRU, or otherwise may be derived from the at least one signal that is received by the WTRU at step 302.

As mentioned above, the measured profile information may include any one or more of the metrics described above. The measured profile information may otherwise or additionally include one or more sets of sensing target positioning information. Suitable sensing target positioning information may include, for example: one or more absolute spatial coordinate sets (e.g., in ‘x’, ‘y’, and ‘z’); one or more relative spatial coordinate sets (e.g., with respect to a location of the TRP and/or the WTRU); or one or more area coordinate sets (e.g., defining a certain range of coordinates, cellular IDs, sector IDs, or any other physical area).

In certain embodiments, the measurement event (e.g., the information indicative of an identification of the target) includes a measurement event identification (ID). The measurement event ID may be used, for example, to correlate a signal from the network (e.g., that can reflect off of the target) with a signal received at the WTRU (e.g., after having reflected off the target). The measurement event ID may include, for example, an ID that can be used for identifying detection of a particular sensing target (e.g., that may be present, among at least one other target, in the LOS of the WTRU and/or the network); an ID that can be used for identifying changes in data associated with detection of the sensing target; or an ID that can be used for identifying a missed detection (e.g., a false positive or a false negative) of the sensing target.

In certain embodiments, the measurement event ID includes an RS ID (e.g., including details of the RS, such as the PRS beam ID, signal strength, frequency band, modulation scheme, AoA, any other suitable details, or any combination thereof).

In certain embodiments, the measurement ID includes a target ID (e.g., where the target ID is associated with the sensing target and optionally includes additional data associated with the sensing target).

In certain embodiments, the measurement event (e.g., the information indicative of an identification of the target) includes a sensing configuration (e.g., a PRS configuration). The sensing or PRS configuration can include, for example, resource information related to the PRS. The resource information can include, for example, a PRS beam ID, a periodicity, a repetition factor, a temporal indication (e.g., a time gap, signal duration, or other suitable temporal data), a comb size, a number of frequency hops, or any combination thereof.

Method 300 also includes step 302, as referenced above, where the WTRU receives at least one signal from the wireless network and generates a measured profile based on the at least one signal. The at least one signal includes information corresponding to the measured profile. The measured profile may or may not correspond to the configured target profile (e.g., the at least one signal target may or may not have been reflected by the target). When the measured profile includes information about the target, it may be a measured target profile or it may be used to derive or otherwise determine a measured target profile. The at least one signal may include multiple signals, where the multiple signals may include a sweep, modulation, or other manipulation (e.g., in frequency, time, or power, and/or with respect to a particular density, comb, or pattern) of signals that are transmitted from the wireless network. The sweep, modulation, or other manipulation may be provided to generate the corresponding measured profile, as mentioned above and as further described below.

Method 300 also includes step 303, where the WTRU determines that the at least one signal was reflected by the target based at least in part on the information indicative of the identification of the target and a comparison between the configured target profile and the measured profile.

In certain embodiments, the configuration specifies that the WTRU performs the determination at step 303 by measuring, calculating, or otherwise determining a difference between a measured profile, as received at step 302, and a configured target profile, as received at step 301. For example, the WTRU may determine that the at least one signal was reflected by the target based on the difference being below a threshold that is included in the configuration.

In certain embodiments, the configuration specifies that the WTRU performs the determination at step 303 by measuring, calculating, or otherwise determining a correlation between a measured profile, as received at step 302, and a configured target profile, as received at step 301. For example, the WTRU may determine that the at least one signal was reflected by the target based on the correlation being above a threshold that is included in the configuration.

In certain embodiments, the configuration specifies that the WTRU performs the determination at step 303 by measuring, calculating, or otherwise determining a difference between a measured location (e.g., of the measured profile), as received at step 302, and a configured location (e.g., of the configured target profile), as received at step 301. For example, the WTRU may determine that the at least one signal was reflected by the target based on the difference being below a threshold that is included in the configuration.

Method 300 also includes step 304, where the WTRU performs sensing measurements associated with the garget using the at least one signal based at least in part on the measured profile generated at step 302. For example, the determination at step 303 can cause a processor of the WTRU to perform a particular sensing measurement (e.g., based on the configuration of step 301). For example, the configured target profile of step 301 may include information associated with the target, and the sensing measurements of step 304 (which may provide the measured profile) may include measured information that represents a real-time, updated, corrected, and/or augmented version of the configured information.

By extracting the measured profile, the sensing measurements at step 304 may provide information on the target's geometric characteristics (e.g., size, dimension, shape, etc.), physical characteristics (e.g., material properties), electromagnetic characteristics (e.g., reflectivity, radar cross section (RCS), etc.), location, mobility data (e.g., velocity and/or acceleration), other characteristics of interest, or any combination thereof. This information on the target's geometric characteristics may also be referred to as the measured target profile (e.g., as may be included within or derived from the measured profile).

In one illustrative and non-limiting embodiment, the configuration of step 301 informs the WTRU of the RCS and approximate location (e.g., the target profile) of a drone (e.g., the target), as well as a frequency-dependent RS power level (e.g., the information indicative of an identification of the target) associated with a signal reflected off of the drone. In this illustrative embodiment, the frequency-dependent RS power level is a measurement profile. In the receiving of step 302, the WTRU receives multiple signals, each signal having a respective frequency and a corresponding RS power level. In the determination of step 303, the WTRU determines that the multiple signals were reflected off of the drone based on an RCS and approximate location associated with the multiple signals being sufficiently close to those described in the configuration of step 301 and based on a frequency-dependent RS power level associated with the multiple signals being sufficiently close to those described in the configuration of step 301. Based on the determination of step 303, the WTRU performs sensing measurements on the at least one signal to determine a current velocity and/or acceleration of the dronc.

Method 300 optionally includes step 305, where the WTRU reports the sensing measurements to the wireless network. The reporting at step 305 can include reporting of the measurement event ID, the sensing configuration, or the target ID, as described at least in connection with step 301. The reporting at step 305 can otherwise or additionally include any one or more of: a detection uncertainty range; the difference between a measured profile and a configured target profile; the correlation between a measured profile and a configured target profile; the difference between a measured target location and a configured target location; RS metrics (e.g., time of arrival (ToA), AoA, RSRP, RSRP, any other suitable RS metric, or any combination thereof); or one or more RS metric profiles (e.g., a distribution of an RS metric across space, time, frequency, AoA ToA, or any other suitable reference).

In certain embodiments, based on the reporting at step 305, the WTRU transmits a signal to the wireless network that causes at least one property associated with the RS signal from the wireless network to be adjusted. For example, the WTRU may request an additional measurement profile and thereby cause the wireless network to transmit multiple signals that generate the corresponding measurement profile after reflecting off of the target.

The method 300 may be provided for detecting targets in sparse sensing environments, with low-power hardware operation, identifying target detection and misdetection (e.g., false positives or false negatives), generalized environment monitoring, any other suitable sensing, or any combination thereof. The method 300 permits the WTRU to perform sensing measurements and generate information about the target based on associations between at least one measured signal (e.g., an RS from the wireless network) and at least one corresponding configured signal (e.g., a target profilc).

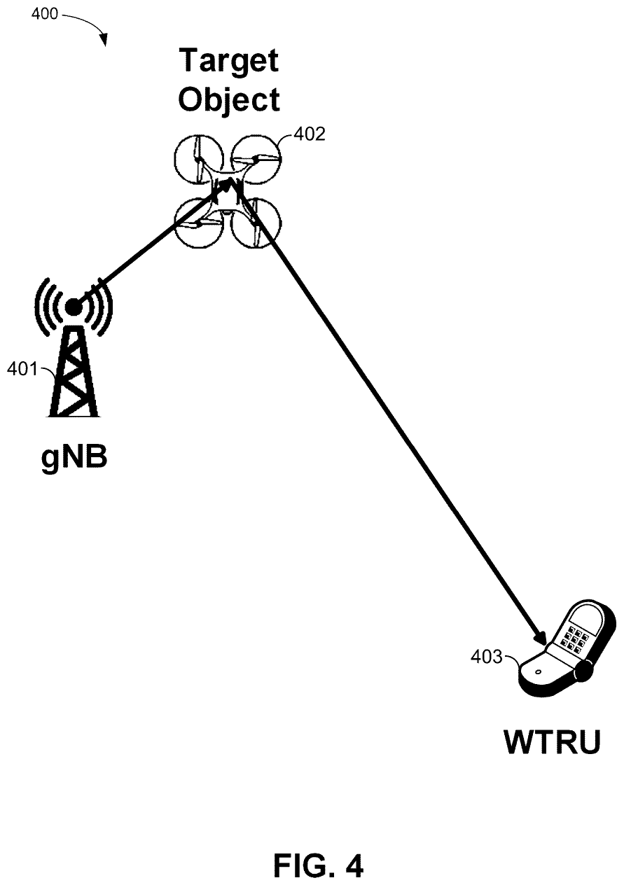

FIG. 4 is an illustrative depiction 400 of how signal reflections can be detected by a WTRU. As shown in FIG. 4, gNB 401 (although any other suitable network element may be provided) transmits a wireless signal. The wireless signal may include any suitable radiofrequency transmission. As shown by the directionality of the arrows, the propagating wireless signal reflects off of target object 402 (e.g., a drone, as shown, although any suitable one or more target objects may be provided), and the reflected signal propagates to WTRU 403. In certain embodiments, the depiction 400 corresponds to the receiving at step 302. Properties of target object 402 affect the reflected signal. As a result, the WTRU 403 can perform method 300 to determine information about the target object 402 based on the signal reflection as shown in depiction 400.

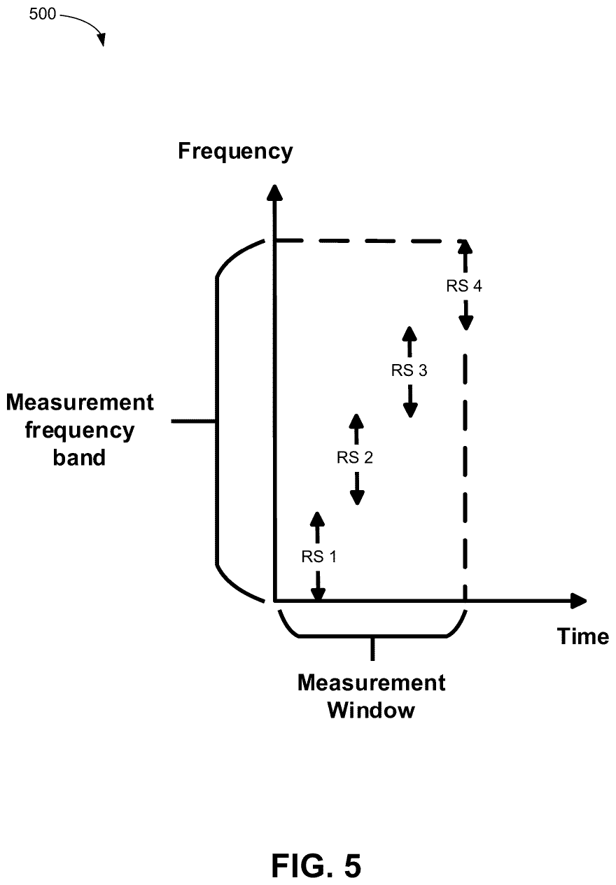

FIG. 5 is an illustrative depiction 500 of how a WTRU can receive multiple reference signals. In the graph as shown, the vertical axis shows a range of frequency values and the horizontal axis shows a range of time values. As annotated, a portion of the frequency range corresponds to a measurement frequency band, and a portion of the time range corresponds to a measurement window (e.g., where the measurement frequency band and window are used by the WTRU at the receiving of step 302). In certain embodiments, the configuration of the WTRU, as provided by the wireless network at step 301, defines a particular measurement frequency band and measurement window. Any suitable range of frequencies and window of times may be provided.

Within both the measurement frequency band and the measurement window, four RSs (i.e., RS 1, RS 2, RS 3, and RS 4, as shown) are received at the WTRU, although any suitable number of RSs may be provided. In certain embodiments, each of these respective RSs corresponds to a respective PRB of the WTRU. Therefore, by leveraging multiple PRBs of the WTRU, multiple RSs can be received within a particular frequency band and/or time window. In certain embodiments, each PRB may be associated with a particular property of the target profile and/or aspect of the information indicative of an identification of the target.

Additional details of the methods, architectures, apparatuses, and systems that are consistent with certain embodiments of this disclosure are provided as follows.

Throughout the embodiments described herein, the target profile (e.g., which may be referred to as a configured target profile at least when the target profile is provided to a WTRU) may refer to any information that describes characteristics of a target (e.g., target object 402 or any other suitable object). The target profile may include geometrical characteristics (e.g., size, dimension, shape, etc.), physical characteristics (e.g., material type(s)), electromagnetic characteristics (e.g., reflectivity, radar cross section (RCS), etc.), location, mobility (e.g., velocity or acceleration), any other suitable information, or any combination thereof.

The target profile may include a single value corresponding to any of the aforementioned information, or it may include multiple values. The multiple values of a target profile may, for example, be evaluated across different time intervals, frequencies, angles, locations, probability distribution functions (PDFs), or other factors that can be modulated.

In one particular example, the target RCS profile may refer to one or more RCS patterns that are associated with the target and evaluated at different frequencies (although evaluation at different angles, time intervals, locations, or PDFs may similarly be provided). Such a target RCS may be referred to as a target RCS frequency profile because the target RCS profile contains multiple RCS values, each corresponding to a respective frequency.

In another particular example, the target RCS profile (i.e., a target RCS angular profile) may refer to one or more RCS patterns that are evaluated at different angles (e.g., angles-of-arrival, angles-of-departure, incidence and/or scattering angle from the target, etc.) associated with at least one signal that is received by the WTRU prior to the evaluation.

Throughout the embodiments described herein, an RS profile (which may also be generally referred to as a measured profile, and may also be more particularly referred to as a measured target profile at least when the RS is associated with a target and measured at a WTRU) may refer to a measured RS metric (e.g., RSRPP, RSRP, RSCP, SINR, etc.) that is measured over different frequencies, time slots, angles, etc.

In certain embodiments, the target profile (e.g., corresponding to the configured target profile) is received at a WTRU, the RS profile (e.g., corresponding to the measured profile) is measured by the WTRU, and the WTRU makes a determination that a target object is being sensed, and/or performs sensing measurements, by comparing the target profile to the RS profile.

Capability information (as further defined below) of the WTRU can affect how the device performs object detection over a wireless network. Accordingly, the WTRU can share capability information with the wireless network, which is described as follows.

In certain embodiments, the WTRU receives and decodes a first network request (e.g., received through RRC signaling or any other suitable communications protocol) from the wireless network to provide capability information. In response, the WTRU may decode this first network request following a random-access procedure or any other suitable decoding procedure. Based on the decoding, the WTRU may prepare a capability information message including information related to sensing capabilities (e.g., for the identification of proximal signal scatterers, object clutter, other environmental information, device information, any other suitable sensing capability, or any combination thereof).

The capability information of the capability information message may include one or more of the following: sensing processing capabilities (e.g., inverse frequency capabilities, Fourier transform capabilities, maximum sampling rate, sampling resolution, number and/or availability of PRBs, etc.); sensing frequency ranges; sensing bandwidth; available sensing modes (e.g., monostatic, bistatic, etc.); sensing priorities; sensing spatial resolution; sensing temporal resolution; capability for AoA determination and related angular resolution; sensing doppler resolution; reflectivity sensitivity (i.e., the minimum power, SNR, absolute amplitude, etc. associated with a reflected signal that can be detected by the WTRU); support of carrier phase measurements and related phase resolution; support of half-duplex or full-duplex transmission for monostatic sensing; or other related parameters (e.g., frequency range, maximum allowed transmit power for sensing, etc.).

In certain embodiments, the WTRU sends the WTRU capability information message through RRC signaling (e.g., over the physical uplink shared channel (PUSCH)) or through any other suitable communication protocol. In response to receiving the WTRU capability information message, the wireless network can optimize its configuration and resource allocation for supporting object detection at the device.

The logical conditions evaluated at the WTRU for triggering the detection of a target (e.g., information indicative of an identification of the target), based on receiving signals reflected off of the target, can affect how the device performs object detection over a wireless network. Accordingly, the WTRU receives information indicative of an identification of the target as part of a configuration that supports how the WTRU performs the object detection over the wireless network.

In certain embodiments, the WTRU may receive triggers (e.g., information indicative of an identification of the target) for initiating the procedure to sense target reflections. Such triggers, along with one or more corresponding configured target profiles, may be part of a configuration received at the WTRU from the network. As specified by one or more triggers, the WTRU can monitor for one or more target profiles. For example, the WTRU may be configured to trigger the initialization of the procedure to sense target reflections associated with at least one target according to time-based, event-based, location-based, mobility-based, or quality of service (QOS)-based triggers, or any other suitable trigger, or any combination thereof.

Upon the detection of one or more triggers, the WTRU initiates the procedure to perform sensing measurements associated with the target. In certain embodiments, initiating the procedure includes performing the sensing measurements based on the configured target profile and the measured profile. In other embodiments, initiating the procedure includes transmitting a message to the wireless network with a request to initiate object sensing. For example, the request to initiate object sensing may cause the wireless network to generate a corresponding wireless transmission that generates target object reflections based on a desired measurement (e.g., an RS profile, RCS profile, or any of the measurements or measurement profiles listed above). The desired measurement may, for example, be based on the configured target profile, including the sensing capability, or any other suitable criterion.

The WTRU can transmit the message to the wireless network with a request to initiate object sensing using an explicit initiation or an implicit initiation. The explicit initiation may include, for example, a message provided via uplink signaling (e.g., RRC signaling, MAC-CE, or uplink control information (UCI)), or a message provided via reference signal transmissions (e.g., sounding reference signal (SRS)). The implicit initiation may include, for example, a selection of certain uplink resources (e.g., resources related to physical random access channel (PRACH), physical uplink control channel (PUCCH), PUSCH, Spatial Relation Info, etc.).

After transmitting the message to the wireless network with the request to initiate object sensing, the WTRU may receive a follow-up configuration from the wireless network. It is noted that the follow-up configuration is described as such with reference to the initial configuration including the configured target profile and the information indicative of an identification the target. The follow-up configuration may specify how to initiate sense target reflections using one or more aspects (e.g., RS profile, RCS profile, etc.) of the initial configuration. The follow-up configuration may otherwise or additionally specify how to report an outcome of the object sensing based on the details provided in the initial configuration.

In certain embodiments, the follow-up configuration may support the WTRU in its performance of sensing measurements associated with the target. Compared to the corresponding initial configuration, such a follow-up configuration may include additional information or more granular information that is associated with the target and that the WTRU can use for detection.

In certain embodiments, a configured target profile associated with the initial configuration is not sufficient for meeting an object detection criterion (e.g., the resulting detection is below a certain sensing resolution, or patterns of the measured profile do not sufficiently match those of the configured target profile). Accordingly, the WTRU can request the wireless network to provide one or more different configured target profiles (e.g., such that the reflected signals may be measured at a different angle, frequency band, etc.).

A sensing measurement configuration (e.g., an initial configuration and/or a follow-up configuration) of the WTRU can affect how the device performs object detection over a wireless network. Accordingly, numcrous configuration types are provided and described as follows.

Typically, the WTRU receives and decodes a first configuration (e.g., an initial configuration including a configured target profile for a target and information indicative of an identification of the target) from the network. The first configuration provides at least one sensing measurement to perform for target sensing. The sensing measurement can include, for example, instructions to detect (and optionally report back to the wireless network) reflections of a transmitted signal by the sensing target. In certain embodiments, the WTRU receives the first configuration via RRC signaling, MAC-CE, DCI, or any other suitable communications protocol.

The information indicative of an identification of the target may include or otherwise be referred to as a measurement event (e.g., which may be associated with one or more measurement event IDs). The measurement event may be configured such that in response to the WTRU recording one or more preconfigured target reflection detection measurements, the WTRU determines that a signal received at the WTRU was reflected by the target. The WTRU further performs at least one sensing measurement associated with the target based on this determination. Configuration of the measurement event may include specifying any one or more of the following parameters.

The measurement event may include a measurement event ID, which may include any one or more of: a measurement event instance ID (e.g., an ID for target reflection detection, ID for target reflection changes above threshold, ID for target reflection misdetection, etc.); an RS ID (e.g., a PRS beam ID(s)), or a target ID.

The measurement event may otherwise or additionally include an indication such as a flag to activate the target reflection detection measurement procedure.

The measurement event may otherwise or additionally include RS information. The RS information may include any one or more of: reference signal types, including but not limited to PRS; resource sets; time and/or frequency characteristics, including but not limited to as pattern and density; cover codes; periodicity; power settings; or beamforming and/or precoding related information (e.g., beam IDs, transmission configuration indicator (TCI) settings, quasi colocation (QCL) information, or any combination thereof).

The measurement event may otherwise or additionally include one or more metrics to be used for the target reflection detection measurement. For example, the one or more metrics may be evaluated as a whole or part of a measured profile (e.g., as is recorded or derived from an RS), and this one or more metrics of the measured profile may be compared to a corresponding metric of the configured target profile. The metric may include any one or more of: RSRP; RSRPP; RSCP; reference signal received quality (RSRQ); SINR; channel quality indicator (CQI); rank indicator (RI); precoding matrix indicator (PMI); or timing advance (TA).

The measurement event may otherwise or additionally include one or more types of RS metric profiles to be measured for the target reflection detection measurement (e.g., to be measured as a whole or part of the measured profile). The RS metric profile may include any one or more of: RS metric-frequency profile information (e.g., relative received amplitude and optionally phase at different frequencies and/or PRBs); RS metric-angular profile (e.g., relative received power at a set of relative AoA and/or AoD); or the RS metric-time profile information (e.g., relative received amplitude and optionally phase at different time slots and/or PRBs).

The measurement event may otherwise or additionally include one or more time windows associated with determining that a detected signal was reflected by the target and/or performing sensing measurements associated with the target. The time window may include any one or more of: a start time; a minimum length of time; a maximum length of time; a delay; a duty cycle; or a repetition rate.

The measurement event may otherwise or additionally include one or more thresholds associated with determining that a detected signal was reflected by the target and/or performing sensing measurements associated with the target. The threshold may include any one or more of: a static threshold to associate an RS reflection to a sensing target; one or more measurement accuracy thresholds; one or more update thresholds; one or more termination thresholds; or a number of measurements to associate with a capability and/or reporting update or a sensing termination.

The measurement event may otherwise or additionally include one or more triggers for initiating at least the target reflection detection measurement procedure (e.g., for initiating the performing of a sensing measurement). The trigger may include any one or more of: time-based triggers (e.g., the WTRU initiating target reflection detection measurements at predefined intervals for periodic monitoring); event-based triggers (e.g., the WTRU initiating target reflection detection measurements when certain signal parameters such as SINR fall below configured thresholds); location-based triggers (e.g., initiating the procedure when WTRU enters and/or leaves certain geographical area, or when it detects proximity to a particular target or location); mobility-based triggers (e.g., initiating the procedure based on a criteria describing whether the WTRU is stationary or mobile); or QoS-based triggers (e.g., initiating the procedure based on sensing accuracy or sensing resolution), including positioning-based QoS (e.g., based on a positioning resolution, e.g., in meters) and reliability-based QoS (e.g., based on a threshold number of missed detections, false alarm percentages, any other reliability metric, or any combination thereof).

In one illustrative example of a location-based trigger, a configuration may trigger the WTRU to initiate target reflection detection if the difference between a measured WTRU location (e.g., using radio access technology (RAT)-dependent and/or independent methods) and a target location provided in a configured target profile is below a certain threshold.

In one illustrative example of a mobility-based trigger, a configuration may trigger the WTRU to activate target reflection detection if the measured WTRU velocity is above a threshold value and/or within a range of threshold values. In another illustrative example of a mobility-based trigger, the configuration may trigger the WTRU to activate target reflection detection if the difference between the measured WTRU velocity and the configured target velocity is below a threshold value.

The measurement event may otherwise or additionally include one or more target reflection detection measurement reporting details. The reporting detail may be associated with a sensing measurement performed at the WTRU and/or a reporting of the sensing by the WTRU to the wireless network. The reporting detail may include any one or more of: reporting type (e.g., periodic, semi-periodic, aperiodic); one or more reporting thresholds (e.g., conditions specifying how the WTRU reports target reflection detection measurement information based on changes in the target reflection detection or other criteria defined in the configuration); reporting content and/or format (e.g., raw versus processed data, statistical or instantaneous data, etc.); reporting resources (e.g., one or more particular uplink resources, including transmission power, resource blocks, scheduling information, or any combination thereof); or error handling and re-sensing strategies.

With reference to method 300, the measurement event (including any one or more of the possible measurement events provided above) may be used in association with the configuration of step 301 (e.g., as part of the configured target profile and/or the information indicative of an identification of the target), the receiving of step 302 (e.g., to specify when or how the at least one signal may be received, including properties of the at least one signal), the determining of step 303 (e.g., to establish at least one criterion that may be evaluated as part of the determination), the sensing measurements of step 304 (e.g., to specify what should be measured by the sensing measurements), and/or the optional reporting of step 305 (e.g., to specify what should be reported to the wireless network).

In certain embodiments, the wireless network may determine the measurement event (e.g., in an initial configuration and/or in a follow-up configuration) based at least in part on sensing capability information provided by the WTRU.

In certain embodiments, the wireless network may determine the measurement event (e.g., in an initial configuration and/or in a follow-up configuration) based at least in part on information (e.g., as specified in a configured target profile and/or a measured profile) associated with the target object.

Sensing assistance information (as further defined below), which may be a whole or part of a configured target profile, of the WTRU can affect how the device performs object detection over a wireless network. Accordingly, the WTRU can receive sensing assistance information from the wireless network, which is described as follows.

In one illustrative example, the WTRU may receive sensing assistance information associated with a particular sensing target from one or more TRPs (e.g., the one or more TRPs transmitting the wireless signal(s) that reflect off of the sensing target). In another illustrative example, the WTRU may receive the sensing assistance information semi-statically (e.g., via LTE positioning protocol (LPP), RRC messages, or any other suitable communication protocol).

The sensing assistance information may include a sensing target ID (e.g., which may be specific to each sensing target, and which may be associated with one or more configured target profiles). The sensing ID may provide a framework through which the WTRU can identify the sensing target based on a received signal. In one illustrative example, the sensing target ID may include a target location (e.g., a first target at (x1,y1,z1) is assigned ID1, and a second target at (x2,y2,z2) is assigned ID2). In another illustrative example, the sensing target ID may include a type-based ID (e.g., where human targets are assigned IDs starting with ‘H’, vehicle targets are assigned IDs starting with ‘V’, and other targets of interest are classified similarly). Any of these suitable sensing target identifiers may be associated with one or more configured target profiles, and each target profile may include one or more sets of information (e.g., the ID1 may include an RCS profile denoted 1-RCS and a location profile denoted 1-loc, where both 1-RCS and 1-loc are specific to the corresponding target object).

The sensing assistance information may otherwise or additionally include an association with a measurement event (and/or measurement event ID). In one illustrative example, the sensing target ID may be the same as, or a component of, the measurement event ID. In another illustrative example, the measurement event ID may be a component of the target ID. In another illustrative example, a single target ID may be associated with multiple measurement event IDs. In another illustrative example, multiple target IDs may be associated with multiple measurement event IDs.

The sensing assistance information may otherwise or additionally include sensing target profile information. The sensing target profile information may include any one or more of: RS metric-frequency profile information (e.g., relative received amplitude (e.g., RSRP, RSRPP, SINR, etc.) and optionally phase (e.g., RSCP) at different frequencies and/or PRBs); RS metric-angular profile (e.g., relative received power at a set of relative AoA and/or AoD); RS metric-time profile information (e.g., relative received amplitude and optionally phase at different time slots and/or PRBs); RCS-frequency profile information (e.g., relative target RCS amplitude and optionally phase at different frequencies and/or PRBs), RCS-angular profile (e.g., relative target RCS at a set of relative AoA and/or AoD); or RCS-time profile information (e.g., relative target RCS amplitude and optionally phase at different time slots and/or PRBs).

The sensing assistance information may otherwise or additionally include sensing target positioning information. The sensing target positioning information may include any one or more of: absolute target coordinates (e.g., in (x,y,z)); relative (e.g., with respect to the coordinates and/or the orientation of the TRP and/or the WTRU) target coordinates; or coarse location information (e.g., where the location is provided as an area that may be defined as covering a range of coordinates, one or more cell ID, one or more sector IDs, etc.).

In one illustrative example of sensing target positioning information that includes relative coordinates, the WTRU may receive the TRP and/or WTRU positioning and/or orientation information from the wireless network, and the WTRU may use this information to calculate the target location relative to the WTRU and/or TRP locations.

The sensing assistance information may otherwise or additionally include sensing target mobility information. The sensing target mobility information may include any one or more of: absolute mobility (e.g., target velocity, target acceleration, Doppler frequency, etc.); relative mobility (e.g., with respect to the WTRU and/or TRP velocity); or an uncertainty range (e.g., as may be associated with velocity, acceleration, and/or Doppler frequency measurements).

The sensing assistance information may otherwise or additionally include a validity time associated with the sensing assistance information. The validity time may refer to the total time duration over which the sensing assistance information can be associated with the target. In one illustrative example, the validity time may be defined in terms of number of symbols, slots, frames, subframes, or seconds of a signal, or any combination thereof.

With reference to method 300, the sensing assistance information (including any one or more of the possible types of sensing assistance information provided above) may be used in association with the configuration of step 301 (e.g., as part of the configured target profile and/or the information indicative of an identification of the target), the receiving of step 302 (e.g., to specify when or how the at least one signal may be received, including properties of the at least one signal), the determining of step 303 (e.g., to establish at least one criterion that may be evaluated as part of the determination), the sensing measurements of step 304 (e.g., to specify what should be measured by the sensing measurements), and/or the optional reporting of step 305 (e.g., to specify what should be reported to the wireless network.

A measurement framework (as further described below) may be included within a configuration. The measurement framework can be provided (e.g., by the wireless network, or based on internal logic) to specify how the WTRU performs object detection over a wireless network.

In one illustrative example of a measurement framework, the WTRU receives an initial configuration including the RS configuration, the target reflection detection time window configurations, and the sensing assistance information (any or all of which may be associated with the configured target profile). In addition (e.g., as part of the initial configuration or as part of a follow-up configuration), the WTRU receives information associated with RS resources to use when determining that the signal was reflected by the target and/or when performing sensing measurements, as well as an indication trigger to initiate the target reflection detection phase.

In another illustrative example of a measurement framework, the measurement framework causes the WTRU to initiate measuring of configured signal parameters (e.g., AoA, RSRP, RSRPP, time of arrival (ToA), etc.) for each RS ID. In certain embodiments, each RS ID may correspond to a respective TRP and/or a respective measurement window.

In another illustrative example of a measurement framework, the measurement framework causes the WTRU to start measuring the RS metric (e.g., RSRP, RSRPP, RSCP, SINR, etc.) profile (e.g., the WTRU records the measured profile) based on the corresponding received RS resource (e.g., based on the configured target profile).

In another illustrative example of a measurement framework, the measurement framework causes the WTRU to measure the RS-metric frequency profile based on a measurement of the RS metric value (e.g., magnitude, power, phase) at different frequencies (e.g., frequency PRBs, bandwidth parts (BWP) s, bands, etc.).

In another illustrative example of a measurement framework, the measurement framework causes the WTRU to measure the RS metric angular profile through the measurement of the RS metric value (e.g., magnitude, power, phase, etc.) at different angles that are associated with the RS resource (e.g., AoA, AoD, etc.).

In another illustrative example of a measurement framework, the measurement framework causes the WTRU to measure the RS metric time profile through measurement of the RS metric value (e.g., magnitude, power, phase, etc.) at different time slots (e.g., time PRBs, symbols, frames, subframes, etc.).

In another illustrative example of a measurement framework, the measurement framework causes the WTRU to be configured by the network to determine the location of the sensing target via measurements. For example, as shown and described above at least in connection with FIG. 3, the WTRU may use multiple specific RS resources, each of which is reflected directly from the sensing target and received at a respective PRB, to estimate the target's location based on one or more of the multiple specific RS resources.

In certain embodiments, with reference at least to any of the abovementioned measurement frameworks, one or more RS metric profiles are provided to correlate a set of RS metric values with a corresponding set of frequencies (and/or any other configurable parameter of the RS).

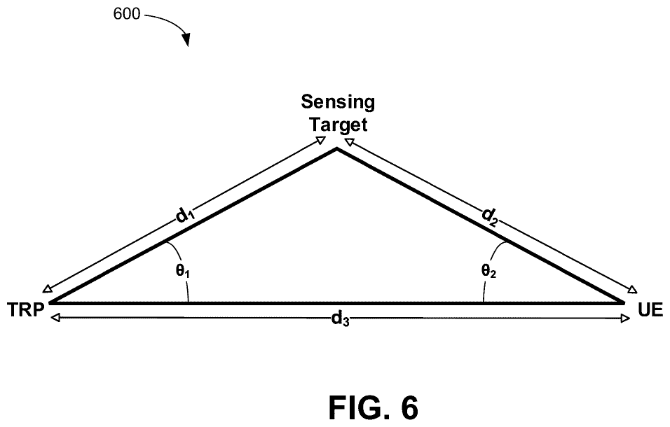

FIG. 6 is an illustrative depiction 600 of geometric relationships that may be used as part of a measurement framework for object detection. In the following illustrative examples, measurement frameworks are provided for using the geometric properties of depiction 600, as annotated in FIG. 6, in object detecting.

In a first illustrative example described in connection with FIG. 6, the WTRU may calculate (e.g., as per the specifications of one or more measurement frameworks) the position of a target based on an RS reflected by the target using the following procedure. (1) Based on information of the coordinates of the TRP and the WTRU, the WTRU calculates the distance (d3) between the TRP and the WTRU. (2) Based on information of the AoD of the received RS, the TRP coordinates, the TRP orientation (e.g., as determined through a rotation matrix) and the WTRU coordinates and/or WTRU orientation, the WTRU calculates the angle θ₁ between the (TRP-target) path and the LoS path (TRP-WTRU). (3) The WTRU measures the time of flight (ToF) (e.g., based on WTRU Rx-Tx time difference) of the received RS beam and calculates the overall (TRP-target-WTRU) path length d₄=d₁+d₂. (4) The WTRU calculates the distance between itself and the target d_{UE_s} as:

$${d}_{UE \_ S} = \frac{{d}_{3}^{2} + {d}_{4}^{2} - 2 {d}_{3} {d}_{4} cos ( {θ}_{1} )}{2 {d}_{4} - 2 {d}_{3} cos ( {θ}_{1} )} .$$

(5) The WTRU calculates the coordinates of the target in the reference domain using the TRP coordinates, the distance between the TRP and the target (d₁) and the TRP orientation (e.g., as determined through a rotation matrix).

With reference at least to the preceding illustrative example, the WTRU may compute the rotation matrix, or the TRP (or other communication point, as described below) may provide the rotation matrix to the WTRU (e.g., as part of an initial or follow-up configuration; e.g., as part of the sensing configuration).

With continued reference at least to the preceding illustrative example, any one or more of a TP (transmission point), RP (reception point), RRH (radio remote head), DA (distributed antenna), BS (base station), particular a sector (of a BS), or particular cell (e.g., a geographical cell area served by a BSTRP) may be considered in place of or in addition to consideration of the TRP.

In a second illustrative example described in connection with FIG. 6, the WTRU may measure an RCS (e.g., as a whole or part of a measured profile) that is associated with a received RS. The WTRU may measure the RCS of the target based on information associated with the target's location using the following procedure. (1) Based on information of the distances d₁ and d₂, the WTRU calculates the corresponding channel gain H (d₁) and H (d₂). (2) Based on measurement of any suitable RS metric (e.g., RSRP, RSRPP, RSCP, CIR, any other RS metric provided in the present disclosure, or any combination thereof), the WTRU measures the channel gain of the received RS resource H. (3) The WTRU calculates the RCS of the target corresponding to the received RS resource as:

$$RCS = \frac{H}{H ( {d}_{1} ) \times H ( {d}_{2} )} .$$

As follows, additional illustrative examples of measurement frameworks are provided. Though these frameworks (and certain other measurement frameworks of the present disclosure) are not explicitly connected to depiction 600, the use of these frameworks in connection with the geometric relationships of depiction 600, and related discussions thereof, may be provided.

In another illustrative example of a measurement framework, the WTRU may measure the RCS profile of a target that corresponds to multiple received RS resources. The WTRU may measure the RCS frequency profile through measurement of the RCS value (e.g., magnitude, phase) at different frequencies (e.g., frequency PRBs, BWPs, bands, etc.).

In another illustrative example of a measurement framework, the WTRU may measure the RCS angular profile through the measurement of the RCS value (e.g., magnitude, phase, etc.) at different angles that are associated with the corresponding received RS resource (e.g., AoA, AoD, etc.).

In another illustrative example of a measurement framework, the WTRU may measure the RCS time profile based on measurements of the RCS value (e.g., magnitude, phase, etc.) at different time slots (e.g., each of the different time slots corresponding to respective time PRBs, symbols, frames, subframes, etc.).

In another illustrative example of a measurement framework, the WTRU may calculate the velocity of a target based on the received RS resource. The WTRU may measure or calculate the velocity of the target as follows. (1) The WTRU measures the Doppler frequency associated with the received RS resource. (2) The WTRU measures the Doppler frequency associated with the target, based on a configured (e.g., as part of the configured target profile) Doppler frequency that is associated with the WTRU mobility, as: f_{ST}=f_{UE}−Δf; where Δf is the measured Doppler frequency associated with the received RS from the target, f_{UE} is the pre-known WTRU Doppler frequency (e.g., based on sensing assistance information, radio access technology (RAT) independent methods, etc.), and f_{ST} is the measured sensing target Doppler frequency. (3) The WTRU calculates the target velocity as: f_{ST}=2v_{ST}COS (v)/λ; where v_{ST} is the velocity of the sensing or detection target, λ is the carrier wavelength, v is the angle between the travel direction of the target and the LoS path between the target and the WTRU.

In another illustrative example of a measurement framework, the WRTU can detect that one or more RS resources are reflected from the sensing target based on one or more of the following calculations: the difference between the measured profile (e.g., RS metric profile, RCS profile, etc.) and the configured target profile (e.g., RS metric profile, RCS profile, etc.) (e.g., where detection may be based on the difference being below a preconfigured threshold); the correlation between the measured profile (e.g., RS metric profile, RCS profile, etc.) and the configured target profile (e.g., RS metric profile, RCS profile, etc.) (e.g., where detection may be based on the difference being above a preconfigured threshold); the difference between the location of a measured profile and the location of a configured target profile (e.g., where detection may be based on the difference being below a preconfigured threshold); or the difference between mobility information (e.g., velocity, acceleration Doppler frequency, etc.) of the measured profile and corresponding mobility information of the configured target profile (e.g., where detection may be based on the difference being below a preconfigured threshold).

In another illustrative example of a measurement framework, the WTRU may associate a specific target that is associated with information of the reflected RS resource (e.g., an RS ID, which may correspond to a measured profile) with a target ID (e.g., which may correspond to a configured target profile). The association between the RS ID and the target ID may be represented as a hard association (e.g., a binary indication of whether or not the measured profile is associated with the configured target profile) or a soft association (e.g., a tiered, scalar, or other quantitative indicator indicating a likelihood of whether or not the measured profile is associated with the configured target profile). The association between the RS ID and the target ID may otherwise or additionally be represented as probability distribution function.

Measurement of uncertainty in target reflection detection (e.g., which may correspond to the uncertainty of a measured profile) can affect how the WTRU performs object detection over a wireless network. For example, an initial configuration may result in a first uncertainty (e.g., above a threshold), which can cause the WTRU to transmit a request to receive a follow-up configuration, which may adjust at least one property of the detection to result in a second uncertainty less than the first uncertainty. For example, the WTRU may be configured to measure and report the uncertainty range associated with the target reflection detection.

In one illustrative example, the WTRU calculates the uncertainty range in AoA of the DL-RS. In certain embodiments, the WTRU may receive the RS resource at an AoA, which is less than the minimum resolution ΔAoAₘᵢₙ that can be detected by the WTRU. In certain embodiments, the WTRU may receive the RS beam at an AoA equal to θ, while the WTRU measures the received PRS beam AoA as θ₁ such that |θ−θ₁|<ΔAoAₘᵢₙ. The difference between the measured AoA and the actual AoA may be a source of uncertainty in the target reflection detection. The WTRU can be configured to reduce the uncertainty in AoA and thus reduce the uncertainty in the target reflection detection.

In another illustrative example, the WTRU calculates the uncertainty range in the ToF of the DL-RS beam. In certain embodiments, the difference between the calculated ToF of the DL-RS resource and the actual ToF of the DL-RS resource is less than AToF, which is the minimum resolution ToF that can be detected by the WTRU. In certain embodiments, the uncertainty range may be equal to the difference between the measured and calculated ToF. The uncertainty in the ToF may result in uncertainty in the calculated distance between the WTRU and the target and/or the TRP. The WTRU can be configured to reduce the uncertainty in ToF and thus reduce the uncertainty in the calculated distance between the WTRU and the target or the TRP.

In another illustrative example, the WTRU calculates the uncertainty range in at least one of the RSRP, RSRPP, RSRQ, RSCP, SINR, combinations of the same, or the like. In certain embodiments, the calculated received power of a DL-RS resource and/or DL-RS resource path may be affected by the channel gain over this path and/or the level of noise and/or the resolution of the WTRU for the minimum power detected. The uncertainty range in these parameters (e.g., RSRP, RSRPP, etc.) may result in a corresponding uncertainty in the measured profile, and uncertainty in the comparison with the configured target profile. The WTRU can be configured to reduce the uncertainty in the measured profile and thus reduce the uncertainty in the comparison distance between the measured and configured target profiles.

In another illustrative example, the WTRU calculates the uncertainty range in one or more measured target locations or target positions. In certain embodiments, this uncertainty range represents a false estimation of the target location. In certain embodiments, this uncertain range can occur due to the WTRU using RAT-dependent or independent methods, due to mobility of the WTRU, and/or due to the time gap between target reflection detection initiation and target reflection detection calculation. The WTRU can be configured to reduce the uncertainty in the measured target location or target position.

In another illustrative example, the WTRU calculates the uncertainty range in one or more target mobility measurements. The WTRU can be configured to reduce the uncertainty in the target mobility measurements.

In another illustrative example, the WTRU calculates the uncertainty range associated with a sensing measurement (e.g., associated with a measurement event or a configured target profile). In certain embodiments, the measurement time window for receiving RSs reflected off of the target can exceed a measurement validity time associated with the configured target profile. The WTRU can be configured to reduce the uncertainty associated with a sensing measurement.

In certain embodiments, the WTRU may represent any of the abovementioned uncertainty ranges, or any other suitable uncertainty range, in the form of probability function (e.g., The RS resource ID X is reflected from Target ID Y with a probability of Z).

In certain embodiments, the WTRU may represent any of the abovementioned uncertainty ranges, or any other suitable uncertainty range, in the form of individual and/or combined uncertainty range(s) of the measured RS metrics or profiles and the measured profile.

In certain embodiments, the WTRU may express an outcome of the comparison between the measured profile and the configured target profile using hard (e.g., associated, not associated, etc.) or soft (e.g., 0, 1, etc.) values. The particular hard or soft value, and the decision of whether to report as a hard or a soft value, may be based at least in part on the detection uncertainty range.

In certain embodiments, the WTRU may determine that the received reflected RS resource is not associated with a configured target profile if the uncertainty range exceeds a maximum preconfigured or dynamically configured threshold.

Measurement reporting (as further described below) may be included within a configuration. The measurement framework can be provided (e.g., by the wireless network, or based on internal logic) to specify how the WTRU performs object detection over a wireless network.

Reporting the sensing measurement (e.g., to the wireless network) can affect how the WTRU performs object detection over a wireless network, and/or it can communicate the sensing measurement to the TRP or devices communicatively coupled to the TRP. For example, the WTRU can perform target reflection detection measurements and then send a target reflection detection measurement report in an aperiodic, periodic or semi-persistent form.

When reporting the sensing measurement, the WTRU may transmit a payload containing one or more of the following aspects over an uplink control or data channel: an RS ID that is reflected from the sensing target; a target ID; a method for target reflection detection (e.g., comparison against the target profile, such as to indicate an artificial intelligence (AI) or machine learning (ML) model that was used in the comparison, etc.); an association criteria of the RS ID to the sensing target (e.g., soft, hard, probability function, etc.); an association level between the RS ID and the sensing target; measurement values associated to the detected reflections (e.g., the difference between the measured profile and the configured target profile; the correlation between the measured profile and the configured target profile; the difference between the measured target location and the configured target location; associated measured RS metrics (e.g., ToA, AoA, RSRP, RSRPP, etc.); and/or associated measured RS metrics profiles); a target detection uncertainty range; or uncertainty ranges of the measurements (e.g., which may be specified as a variance of the obtained reference signal metrics (e.g., RSRP, RSRPP, absolute or relative phase, instantaneous frequency shifts, etc.)).

Updating a reported sensing measurement (e.g., to the wireless network) can affect how the WTRU performs object detection over a wireless network. For example, the WTRU can cause the wireless network to change at least one aspect of its transmission, and/or it can cause the wireless network to provide a follow-up configuration, to improve a detection capability of the WTRU.

In one illustrative example, the WTRU determines the target reflection detection and its associated uncertainty range obtained after performing a suitable number of measurements. Based on these measurements, the WTRU determines that the measurement event (e.g., a detected RS ID, an RS association to a sensing target, and/or any other suitable measurement event) and/or the measured profile are invalid or outdated.

The WTRU may determine that a measurement event and/or a measured profile are invalid or outdated based on any one or more of the following: a change in the measured target location and/or the difference between the measured target location and the configured target location is above a preconfigured threshold; a time lapse associated with a most recent, or any two, sensing measurements being greater than a validity time associated with the configured target profile; a change in the measured WTRU position and/or orientation (e.g., using RAT-dependent and/or independent methods) exceeding a preconfigured threshold; a measured target velocity and/or Doppler frequency of the associated RS (e.g., that is reflected by the target) being above a preconfigured threshold; a change in the TRP status; a change in the RS configuration (e.g., PRS beam ID(s), periodicity, repetition factor, time gap, comb size, number of frequency hops, etc.); an uncertainty range associated with the target reflection detection being above a threshold; or a determined association between an RS ID and the sensing target is below a threshold.

In one illustrative example provided in reference to the abovementioned change in TRP status, the WTRU may be configured to update its report of a measured profile if the status of the TRP (e.g., which transmitted the signal that was reflected by the target and received by the WTRU) changes from connected to disconnected, or vice versa. In another illustrative example, the WTRU may be configured to update its report of a measured profile if the status of a group of TRPs (e.g., determined by a threshold number or TRP IDs) changes from connected to disconnected, or vice versa.

In response to determining to provide an updated reported sensing measurement, the WTRU may provide the updated report in an aperiodic, periodic, or semi-persistent form over a UL control, data channel, or other suitable communication protocol. The update to the reported sensing measurement may include any one or more of the following: an updated measured profile with an updated uncertainty range; updated RS IDs that are associated with the sensing target; an updated association level between the RS ID and the sensing target; updated measurements that are associated with the measured profile, which may include corresponding updated uncertainty ranges; the difference between the current uncertainty range and the previous uncertainty range (e.g., as was calculated in connection with a previous measured profile); or a reason for the update (e.g., which may reference any one or more measured parameters, such as the measured profile, association level, etc.).

In certain embodiments, the WTRU may be configured to report the invalidity of a previous measured profile to the network. The WTRU may determine that such a measured profile was invalid based on a comparison between the measured profile and the configured target profile. The WTRU may otherwise or additionally determine that such a measured profile was invalid based on one or more uncertainty ranges being greater than a threshold uncertainty.

One or more policies for terminating the performing of sensing measurements can affect how the WTRU performs object detection over a wireless network. For example, the WTRU can be configured to perform a series of measurements (e.g., that may be recorded at a multi-slot level, and/or that may be based on a configured repetition factor, time gap, or other factor) and to terminate performing the sensing measurements based on a property of the measurements.

In certain embodiments, the WTRU determines to terminate the performing of the sensing measurements based on any one or more of the following: one or more of RS reflection measurements being under a threshold value for a threshold amount of time; the difference between multiple respective measured profiles (e.g., RS metric profile, RCS profile, etc.) being below a threshold (e.g., the variance being sufficiently small); the change in the measured difference between the configured target profile and the measured profile (e.g., RS metric profile, RCS profile, etc.) over multiple measurement instances being below a threshold; the change in the measured correlation between the configured target profile and the measured profile (e.g., RS metric profile, RCS profile, etc.) over multiple measurement instances being below a threshold; the change in the measured target location over multiple measurement instances being below a threshold; the change in the measured target mobility over multiple measurement instances being below a threshold; the uncertainty in the measured profile being above a threshold (e.g., across multiple measurements instances); or a termination indication by the network.

In certain embodiments, the WTRU sends a termination message to the wireless network (e.g., over a UL control, data channel, or any other suitable communication protocol). For example, the termination message may include any one or more of the following: indication of the termination; recommendation to terminate; termination time stamp; termination reason; or the final measured profilc.

In one illustrative example, the indication of the termination may also include information on the termination reason. For example, a termination indicator=1 may be configured to refer to an uncertainty range being above a configured threshold for N measurement occasions, and a termination indicator=2 may be configured to refer to the allocation of WTRU resources to other higher priority tasks. As it relates at least to the uncertainty range, the termination reason may be based on a change in the measured profile (e.g., based on a classified target category, sensing measurements, or estimated location or velocity) across N measurement occasions. As it relates to at least the WTRU resource allocation, the WTRU may report to the network other higher priority tasks to be executed, and optionally a priority order associated with the higher priority tasks and the object detection (e.g., based on RCS profile measurements).

In certain embodiments, the final measured profile, as can be associated with a measurement termination, includes some or all information requested by the wireless network. The final measured profile may include one or more metrics used in connection with the measured profile (e.g., one or more of the matched target profile index, RS signal ID used for detection, etc.).

It is noted that throughout this disclosure: sensing and detection, or variations thereof, may be used interchangeably; either of the transmitted signal or the received signal (e.g., that is reflected off of the target), or variations thereof, may be referred to as an RS or a variation thereof, and may be used interchangeably; and the sensed and/or detected target reflections, sensed target profile, or variations thereof, may refer to the measured profile, and vice versa.

As used in connection with the embodiments of this disclosure, a sensing target, target object, detection target, or variations thereof, may be used interchangeably and may refer to any suitable object (e.g., a vehicle, drone, animal, human, building, device, surface, projectile, one or more aspects of a landscape, or any other suitable object).

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 6 or means-plus-function claim format, and any claim without the terms “means for” is not so intended.

What is claimed is:

1. A method performed by a wireless transmit/receive unit (WTRU), the method comprising:
receiving, from a wireless network, a configuration that comprises a configured target profile for a target and information indicative of an identification of the target, wherein the configured target profile comprises a radar cross section profile associated with the target;
receiving at least one signal from the wireless network;
generating a measured profile based on the at least one signal;
determining that the at least one signal was reflected by the target based at least in part on the information indicative of the identification of the target and a comparison between the configured target profile and the measured profile; and
performing sensing measurements associated with the target using the at least one signal based at least in part on the measured profile.

2. The method of claim 1, wherein the configured target profile further comprises an aspect of the at least one signal, the aspect comprising at least one of: positioning information, a power, a power per path, a phase, an amplitude, a frequency, an angle-of-arrival, a signal-to-interference-noise ratio, a signal quality, a rank indicator, a precoding matrix indicator, a density, a comb size, a number of frequency hops, a beam ID, a periodicity, a repetition factor, or a timing advance.

3. The method of claim 1, wherein the configured target profile further comprises a set of values, each value of the set of values corresponding to a respective at least one of a frequency, time, phase, resource block of the WTRU, or angle-of-arrival.

4. The method of claim 1, wherein:
the information indicative of the identification of the target comprises a condition associated with a property of the at least one signal, wherein the property comprises at least one of a signal type, pattern, density, cover code, periodicity, power, beam identification, transmission configuration indicator, or quasi colocation information; and
the determining is in response to the condition being satisfied.

5. The method of claim 1, wherein the determining comprises:
evaluating a difference between the configured target profile and the measured profile;
comparing the difference to a threshold; and
making the determination based on the comparison.

6. The method of claim 1, wherein the determining comprises:
evaluating a correlation between the configured target profile and the measured profile;
comparing the correlation to a threshold; and
making the determination based on the comparison.

7. The method of claim 1, wherein:
the configured target profile further comprises sensing assistance information comprising:
one or more absolute coordinate sets associated with the target,
one or more relative, with respect to the WTRU, coordinate sets associated with the target,
one or more physical areas associated with the target,
mobility information associated with the target, or
reflection information associated with the target, and
the determining is further based on the sensing assistance information.

8. The method of claim 1, further comprising transmitting a message comprising information associated with the sensing measurements to the wireless network.

9. The method of claim 1, further comprising transmitting a sensing capability to the wireless network, wherein the configuration is based on the sensing capability.

10. The method of claim 9, wherein the sensing capability comprises at least one of: an inverse frequency transform capability, a maximum sampling rate or number of samples, a sensing frequency range, a sensing bandwidth, one or more available sensing modes, a list of sensing priorities, a sensing spatial resolution, a sensing temporal resolution, a capability or resolution for supporting angular measurements, a sensing doppler resolution, a sensitivity to reflectivity, a minimum power requirement, a minimum SNR requirement, an absolute amplitude range, a capability to for supporting phase measurements, an indication of half-duplex or full-duplex sensing, an indication of monostatic or bistatic sensing, or a maximum allowed transmit power associated with transmitting the sensing capability.

11. A wireless transmit/receive unit (WTRU) comprising:
a processer, and
a transceiver coupled to the processer, wherein the WTRU is to:
receive, from a wireless network, a configuration that comprises a configured target profile for a target and information indicative of an identification of the target, wherein the configured target profile comprises a radar cross section profile associated with the target;
receive at least one signal from the wireless network;
generate a measured profile based on the at least one signal;
determine that the at least one signal was reflected by the target based at least in part on the information indicative of the identification of the target and a comparison between the configured target profile and the measured profile; and
perform sensing measurements associated with the target using the at least one signal based at least in part on the measured profile.

12. The WTRU of claim 11, wherein the configured target profile further comprises an aspect of the at least one signal, the aspect comprising at least one of: positioning information, a power, a power per path, a phase, an amplitude, a frequency, an angle-of-arrival, a signal-to-interference-noise ratio, a signal quality, a rank indicator, a precoding matrix indicator, a density, a comb size, a number of frequency hops, a beam ID, a periodicity, a repetition factor, or a timing advance.

13. The WTRU of claim 11, wherein the configured target profile further comprises a set of values, each value of the set of values corresponding to a respective at least one of a frequency, time, phase, resource block of the WTRU, or angle-of-arrival.

14. The WTRU of claim 11, wherein:
the information indicative of the identification of the target comprises a condition associated with a property of the at least one signal, wherein the property comprises at least one of a signal type, pattern, density, cover code, periodicity, power, beam identification, transmission configuration indicator, or quasi colocation information; and
the determination is in response to the condition being satisfied.

15. The WTRU of claim 11, where the determination comprises:
evaluating a difference between the configured target profile and the measured profile;
comparing the difference to a threshold; and
making the determination based on the comparison.

16. The WTRU of claim 11, where the determination comprises:
evaluating a correlation between the configured target profile and the measured profile;
comparing the correlation to a threshold; and
making the determination based on the comparison.

17. The WTRU of claim 11, wherein:
the configured target profile further comprises sensing assistance information comprising:
one or more absolute coordinate sets associated with the target,
one or more relative, with respect to the WTRU, coordinate sets associated with the target,
one or more physical areas associated with the target,
mobility information associated with the target, or
reflection information associated with the target, and
the determining is further based on the sensing assistance information.

18. The WTRU of claim 11, wherein the WTRU is further to transmit a message comprising information associated with the sensing measurements to the wireless network.

19. The WTRU of claim 11, wherein the WTRU is further to report a sensing capability to the wireless network, wherein the configuration is based on the sensing capability.

20. The WTRU of claim 19, wherein the sensing capability comprises at least one of: an inverse frequency transform capability, a maximum sampling rate or number of samples, a sensing frequency range, a sensing bandwidth, one or more available sensing modes, a list of sensing priorities, a sensing spatial resolution, a sensing temporal resolution, a capability or resolution for supporting angular measurements, a sensing doppler resolution, a sensitivity to reflectivity, a minimum power requirement, a minimum SNR requirement, an absolute amplitude range, a capability to for supporting phase measurements, an indication of half-duplex or full-duplex sensing, an indication of monostatic or bistatic sensing, or a maximum allowed transmit power associated with transmitting the sensing capability.
